(19) United States
(12) Patent Application Publication
(10) Pub. No.: US 2024/0321128 A1
(43) Pub. Date: Sep. 26, 2024

(54) AIRPORT SIGNALLING SYSTEM WITH ULTRA-WIDEBAND COMMUNICATION CAPABILITY

(71) Applicant: ADB Safegate BV, Zaventem (BE)

(72) Inventors: Luca Menè, Palm Jumeirah (AE); André Jelu, Hoegaarden (BE); Wim Penninckx, Zaventem (BE)

(21) Appl. No.: 18/579,548

(22) PCT Filed: Jul. 15, 2022
(86) PCT No.: PCT/EP2022/069839

§ 371 Date: Jan. 16, 2024

(30) Foreign Application Priority Data
Jul. 16, 2021 (EP) 21186220.6

(51) Int. Cl. G08G 5/06; B64F 1/00; B64F 1/20; H04B 1/7163

(52) U.S. Cl. CPC G08G 5/065; B64F 1/002; B64F 1/20; H04B 1/7163

(57) ABSTRACT

Airport signalling system, comprising: at least one signalling unit (200), each comprising at least one airport signalling device and a first communication device; a control unit configured to control operation of the at least one signalling unit (200), a central communication unit operably coupled to the control unit and configured for data communication with at least one signalling unit (200), characterised in that the at least one signalling unit (200) comprises at least two signalling units (200) including each a first communication device configured to receive and/or transmit ultra-wideband pulse radio signals and in that said the at least two signalling units (200) are configured to exchange ultra-wideband pulse radio signals through their respective first communication device.

### TECHNICAL FIELD

The present invention is related to airport signalling system adapted for ultra-wideband communication.

### BACKGROUND ART

In airport, Aeronautic Ground Lighting (AGL) is used to support pilots during landing, take-off and ground movement of their aircrafts. The aeronautic ground lighting comprises different items such as cable circuits, transformers and lights, which are typically powered from an AGL power station. Aeronautic ground lighting allows a control and monitoring, to the level of individual or group of lights. Such a control and monitoring takes place in an Air Traffic Control (ATC) tower as well as at other locations usually dedicated to the maintenance. The control of individual or group control of lights, depending the operational needs, is typically performed using power line communication or via dedicated communication cables. The use of dedicated communication cables however does increase the complexity of the installation. Equally, power line communication does present limitations as a sufficient data transfer rate is difficult to sustain especially when high performance and reliability of the communication path is required. In this context, the ground lights are restricted to the initial function of visual aids. The above mentioned communication issues limit access to data and the uses of diagnosis methods applied to ground lights as well as the extent of their monitoring.

### SUMMARY OF THE INVENTION

There is therefore a need in the art of providing an airport signalling system that overcomes the above mentioned drawbacks, especially there is a need in the art of providing aeronautical ground lighting system allowing easier maintenance and monitoring. There is also a need for improving the level of surveillance of the airfield providing better situation awareness to the users.

According to an aspect of the invention, there is therefore provided an airport signalling system, comprising at least two signalling units, each comprising at least one airport signalling device and a first communication device;
a control unit configured to control operation of the at least two signalling units, a central communication unit operably coupled to the control unit and configured for data communication with the at least two signalling units and the control unit, characterised in that the first communication device of each signalling unit is configured to receive and transmit ultra-wideband pulse radio signals and in that the at least two signalling units are configured to exchange one another ultra-wideband pulse radio signals through their respective first communication device.

### BRIEF DESCRIPTION OF THE FIGURES

Aspects of the invention will now be described in more detail with reference to the appended drawings, wherein same reference numerals illustrate same features and wherein:

FIG. 1 discloses a schematic representation of an aeronautic ground light according to the invention;

FIG. 2 represents a setup of aeronautic ground lights according to the invention;

FIG. 3 represents a wireless ultra-wideband network according to the invention;

FIG. 4 represents a setup of aeronautic ground lights according to the invention comprising both power line communication and ultra-wideband communication;

FIG. 5 represents another aeronautic ground light according to the invention.

FIG. 6 represents a wireless ultra-wideband network according to the invention as shown in FIG. 3 with communications layers.

### DETAILED DESCRIPTION

By signalling unit (also known as airport signalling device) 200 is meant any device used providing visual guidance to pilots for landing, take off and ground movement until the park position of the aircraft. Signalling unit 200 comprise visual aids such as Aeronautical Ground lighting (AGL) lights, Visual Docking Guidance Systems (VDGS). We understand by an airport surveillance stationary device a fixture/device/apparatus dedicated to an airfield surveillance (e.g. camera, a multilateration system).

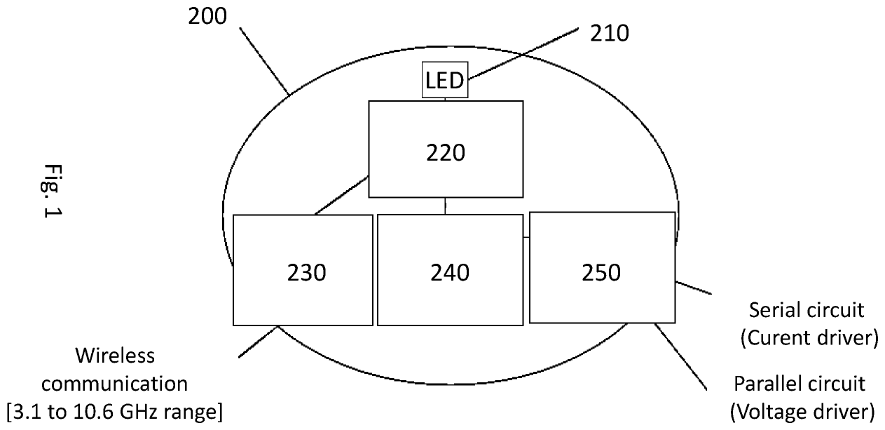

FIG. 1 represents a signalling unit 200 comprising a light source 210, in particular a LED (Light Emitting Diode) controlled by a light controller 220. The light controller 220 receives control commands for operating the light source 210 via two possible channels: ultra-wideband antenna and power line communication. In other words, the signalling unit 200 includes two communications devices, namely a ultra-wideband communication device 230 and power line communication device 240. The power communication device 240 is operatively coupled to a power module 250, that typically comprises a connection terminal for connection to a power supply. The ultra-wideband communication device is configured to wirelessly receive control commands for operating the at least one aerodrome signalling device 210. The signalling unit 200 can comprise one or more sensors (not shown) for measuring data representative of a condition or event inside or outside the signalling unit 200. The one or more sensors are configured to communicate status data to the ultra-wideband communication device 230, and optionally power line communication device 240.

By ultra-wideband (UWB) is meant a pulse radio whose frequency lies in the range of 3.1 to 10.6 GHz range. For this purpose, the signalling unit 200 comprises one or more RF antenna supporting the UWB communication. FIG. 1 shows a signalling unit 200 with two communication devices 230, 240. However, another embodiment of the invention, a signalling unit 200 contains an UWB communication device 230 alone or in combination with another Wireless communication means such using a WiFi, 4G/LTE or 5G/LTE protocols (not shown).

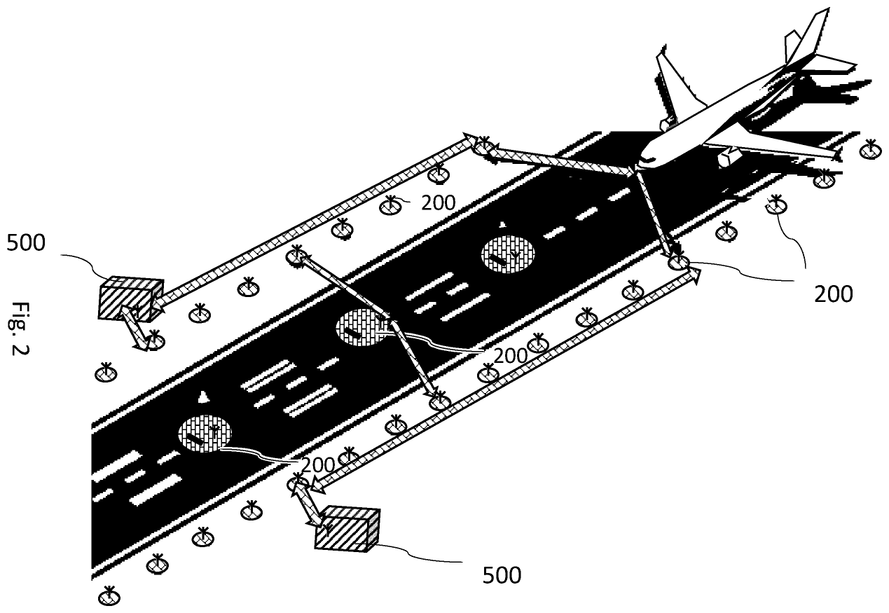

FIG. 2 shows a network of signalling units 200 arranged on a central line and sides of an airport runway. The signalling units 200, in particular visual aids are each provided with UWB communication device 230, that receives an unique factory set of identifiers to support method of communication in peer to peer or in communities. Communication quality and reliability grows with the number of communication participants, namely signalling units 200.

The plurality of signalling units 200 can receive in a dynamic way ultra-wideband communication signals at various power levels. A predefined group of signalling units 200 can be provided with processes to repeat/forward messages.

The plurality of signalling units 200 can receive in dynamic way ultra-wideband communication signals, then can treat the received data when addressed to their unique identifier.

The plurality of signalling units 200 can transmit in a dynamic way data form relay communication units 500, being a signalling unit 200 configured as relay for a group of units, to aircrafts or vehicles. For instance, data broadcasted can relate to a computer voice message (e.g. as in EP1984905B1) or a message string to cockpit display.

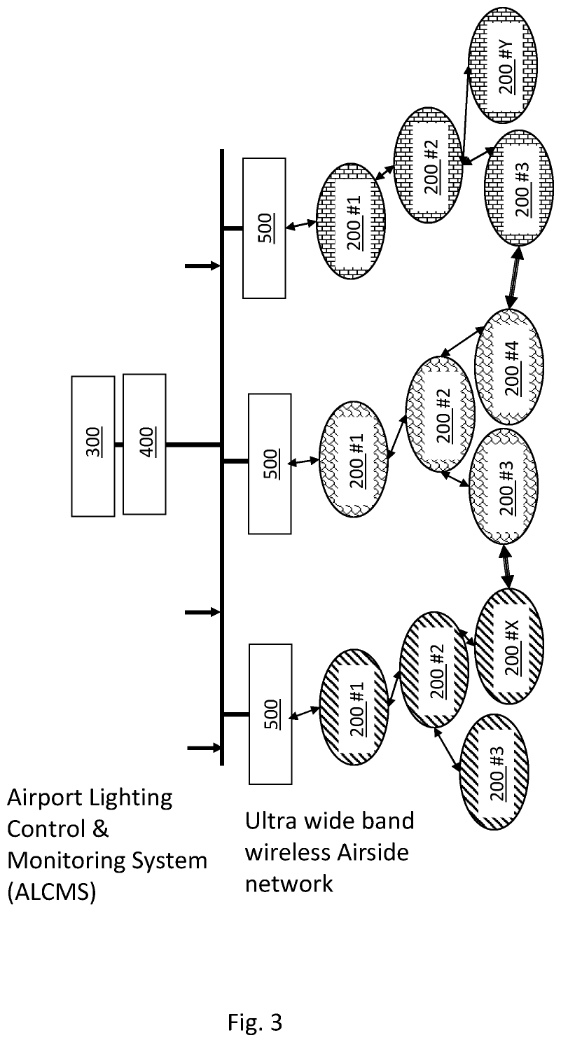

Relay communication units 500, being a signalling unit 200 configured as relay for a group of units, can comprise a first computing unit configured to determine and monitor optimised wireless communications paths within the one or more clusters of signalling units 200, as shown in FIG. 3.

FIG. 2 shows two clusters of signalling units 200. For instance, messages destined to the airplane can be transferred via the first cluster extending along one side of the runway. Messages sent by the airplane can be transferred via the second cluster extending along the other side of the runway so at to balance the clusters. Alternatively, the second cluster can ensure the outbound data transfer and the first cluster the return data transfer. Each cluster is connected to a relay communication unit 500. Runway centre ground lights 200 can belong alternately to the first and the second cluster and allow communication between the two clusters at different locations increasing the number of possible communication paths and therefore the commutation reliability with an air plane, a vehicle, a tag worn by a person or a mobile phone, when equipped with UWB technology. Alternatively, the runway centre ground lights 200 can belong to a third cluster. Equally, the monitoring of aeronautical ground lights status can be improved by such network architectures.

The airport signalling system 100 can comprise at least one of the following means:
The ultra-wideband communication device 230 of each signalling unit 200 comprises a computing unit that dynamically analyses and records at least one of: signal levels, message quality, response time, and/or group reference;
Messages not addressed to a given group of signalling units 200 are broadcasted again to another group until the messages reached the addressed group of signalling units 200;
The relay communication units 500, being a signalling unit 200 configured as relay for a group of units, ensure that the fastest and most reliable path is selected to pass messages to a given signalling unit 200;
The relay communication units 500 is operably connected to the central communication unit 400. The relay communication units 500 can comprise a second computing unit for controlling the “wireless” communications and/or “wire” communications, via the physical network for instance comprising fibre-optic communication lines. Alternatively, the first computing unit of the or each communication unit 500 ensures the controlling the “wireless” or “wire” communications. The groups of ultra-wideband communication devices 230 and the physical network form a ultra-wideband wireless communication infrastructure.

Signalling units provided with ultra-wideband communication have timeout settings ensuring safe mode.

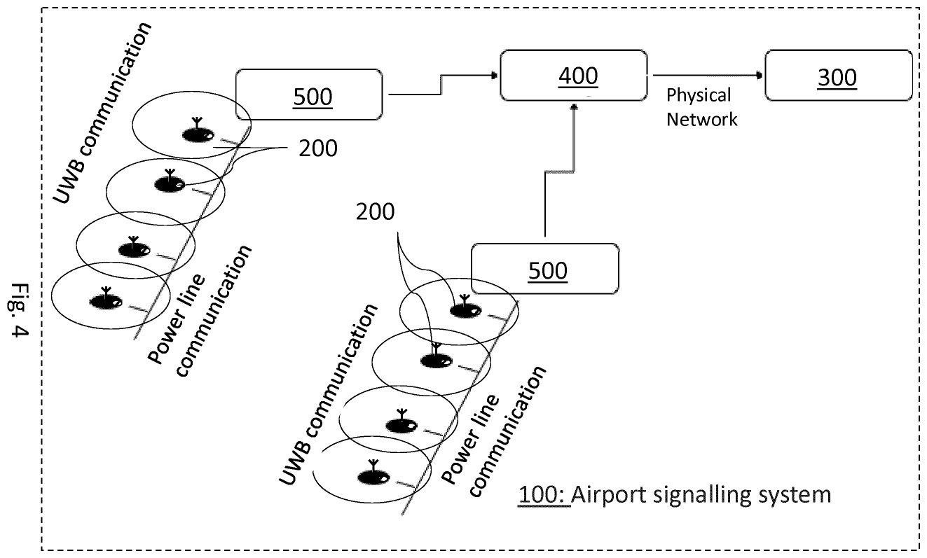

FIG. 4 represents a setup of aeronautic ground lights according to the invention comprising both power line communication and ultra-wideband communication. In FIG. 4, the powerline communication channel used by the aeronautic ground lights are used to connect the signalling unit 200 via the respective second communication interfaces 240 to the corresponding relay communication units 500 arranged for instance in aeronautic ground light substation. The relay communication units 500 are then connected via physical network or wireless connection to the central 5 communication unit 400, which is operably connected to the control unit 300.

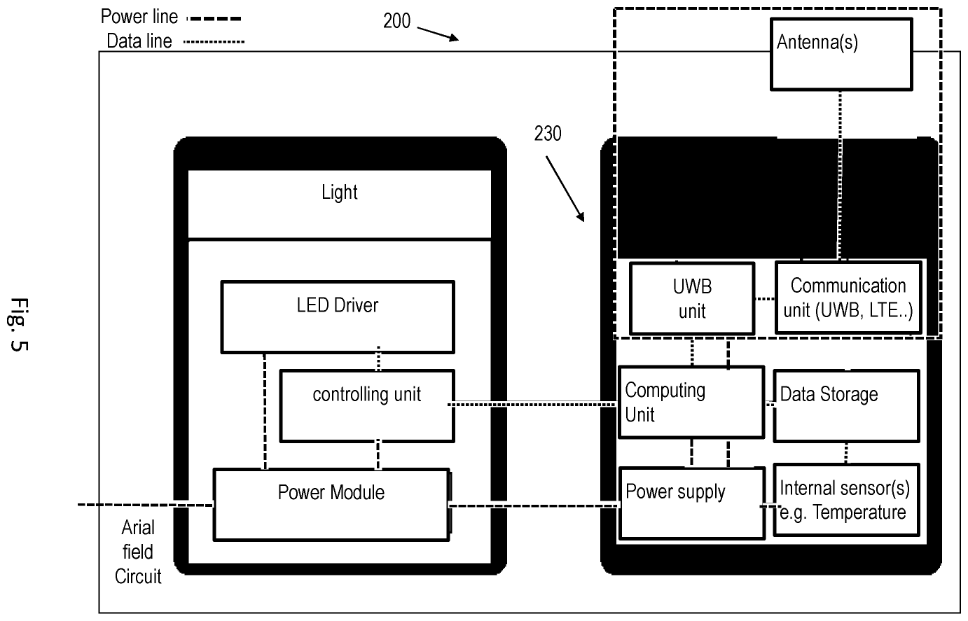

FIG. 5 shows an airport light-signalling device 200, namely a signalling unit, in which a first communication device 230 is arranged. The first communication device 230 is adapted to exchange data with at least one moving entity on an airfield, in particular an airplane, a ground vehicle, a tag worn by a pedestrian, a mobile phone, through one or more ultra-wideband pulse radio signals which are received via one or more antennas (radar(s)) of first communication device 230. The first communication device 230 is operatively connected via the relay communication unit (500 not shown) with central communication unit 400 (not shown).

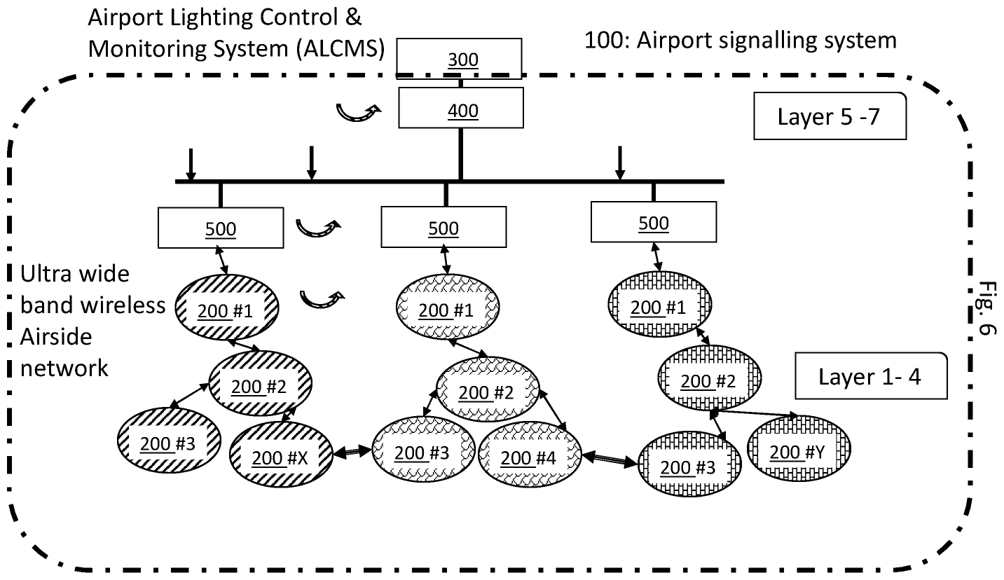

The central communication unit 400 is operatively connected to one or more moving entities such as an airplane, a ground vehicle, for data communication. The central communication unit 400 is configured for data communication with the at least one or more moving entities provided with an ultra-wideband communication device via the (first) communication device 230 of the signalling units 200. The network of the first communication devices 230 can be extended to include other elements in particular other moving entities or an airport surveillance stationary device, namely a multilateration remote unit, in order to broaden the network coverage. The central communication unit 400 comprises a centralized processor being configured to run programmed instructions for performing at least one of the following steps: receiving a UWB data signals from the signalling units, executing the instruction to determine: most reliable and fastest communication path from data obtained from the first communication device, autonomously and continuously updating and adapting the communication path without impacting the data package deliveries, identifying and labelling the first communication devices, and/or selecting the first communication devices 230. The centralized processor (integrated in the communication unit 400) ensures the software hosting layer (layer 5 to 7), while the communication infrastructure is based on UWB layer 4, as illustrated in FIG. 6.

The centralized processor of the communication unit 400 is configured to receive data signals from a network of distributed signalling units 200 (the centralized processor therefore has high throughput capability to receive a number of individual devices that may reach a couple of thousand in numbers) and to merge the above mentioned data and select the most accurate data to achieve high reliable communication with build in redundancy.

The centralized processor of the communication unit 400 is provided with a memory to store the signal analysis and calculated communication path(s) with time of calculations.

The centralized processor of the communication unit 400 is configured to compare signal strengths of all data received in a configurable time window with ranging previously calculated and stored in the memory and associate the ones related to the same moving entity.

The centralized processor of the communication unit 400 is configured to transmit data smoothed using the calculated path of entities to an external user or higher-level system.

In FIG. 5, the first communication device 230 forms an unit that is integrated in a “traditional” signalling unit 200, namely airport light-signalling device. Control interfaces between first communication device 230 and its signalling unit 200 ensure that a computing unit of the first communication device 230 can control the controlling unit of airport light-signalling device. This situation occurs when the light control signals to control the airport light-signalling device are for instance received remotely via a 5G antenna mounted on the communication device 230 or via the UWB network formed by a network of first communication devices 200.

In FIG. 5, the airport light-signalling device is connected to a power supply line. Light control data can also be transferred though the power supply line and received by the controlling unit.

In case of failure of the first communication device 230 or extreme atmospheric conditions (high temperature), the first communication device 230 is either remotely or automatically shut down. In such a situation, the airport light-signalling device can keep on operating thanks to its modular structure.

The communication device 230 comprises a communication unit configured to exchange data wirelessly, in particular using UWB or cellular communication.

Other embodiments of the invention are defined by the following clauses:
1. Airport signalling system (100), comprising:
   at least one signalling unit (200), each comprising at least one airport signalling device (210) and a first communication device (230);
   a control unit (300) configured to control operation of the at least one signalling unit (200),
   a central communication unit (400) operably coupled to the control unit and configured for data communication with at least one signalling unit (200),
   characterised in that the at least one signalling unit (200) comprises at least two signalling units (200) including each a first communication device (230) configured to receive and/or transmit ultra-wideband pulse radio signals and in that the at least two signalling units (200) are configured to exchange ultra-wideband pulse radio signals through their respective first communication device (230).
2. Airport signalling system (100) of clause 1, wherein the first communication device (230) of the at least one airport signalling unit is configured for data communication with at least one moving entity on an airfield, in particular an airplane, a ground vehicle, a tag worn by a pedestrian, a mobile phone, preferably said entity (200) being provided with an ultra-wideband communication device configured to exchange data with at least one first communication device (230) of the at least two signalling unit (200).
3. Airport signalling system (100) of any one of the preceding clauses, wherein the at least one signalling unit comprises at least a first group of signalling units (200) arranged in cluster like structure covering a first zone of interest, and said signalling system (100) further comprising a first relay communication unit (500), wherein a first signalling unit (200) of the first group is positioned within a ultra-wideband coverage range of the first relay communication unit (500).
4. Airport signalling system (100) of any one of the preceding clauses, wherein one or more of the at least two airport signalling units (200) are an aeronautic ground light, an airport sign, an airport guard light, flood light, taxiway light, apron light or visual docking guidance display.
5. Airport signalling system (100) of any one of the preceding clauses, further comprising at least one airport surveillance stationary device, preferably a multilateration ground station, said device being provided with an ultra-wideband communication device configured to exchange data with at least one first communication device (230) of the at least two signalling unit (200)
6. Airport signalling system (100) of any one of the preceding clauses, wherein the first group of the signalling units (200) are positioned along a first path, preferably rectilinear, and/or a proximal or distal signalling unit (200) of said first group being the first signalling unit of said first group.
7. Airport signalling system (100) of any one of the preceding clauses, wherein the first path is arranged:
   in a central line of one of a runway, taxiway and an apron and/or
   along one or both opposite sides of the one of a runway, taxiway and an apron.
8. Airport signalling system (100) of any one of the preceding clauses, wherein the at least one of the signalling units comprises a second group of signalling units (200) arranged in cluster like structure to cover a second zone of interest, and said signalling system (100) further comprises a second relay communication unit (500), wherein a first signalling unit (200) of the second group is positioned within an ultra-wideband coverage range of first relay communication unit (500).
9. Airport signalling system (100) of any one of the preceding clauses, wherein the minimal distance between any pair of directly adjacent signalling units (200) of the first or second group is greater or equal to 11 meters, preferably 15 meters, in particular 20 meters.
10. Airport signalling system (100) of any one of the preceding clauses, wherein the second group of the plurality of the signalling units (200) are positioned along a second path, preferably rectilinear, and/or a proximal or distal signalling unit of said second group is the first signalling unit of the second group.
11. Airport signalling system (100) of the preceding clause, wherein the first path is substantially parallel to the second path, preferably both paths being arranged on opposite long sides of a runway.
12. Airport signalling system (100) of any one of the preceding clauses, wherein at least one of the signalling units (200) of the first group and at least one of the signalling units (200) of the second group are in data communication via their respective first communication device (230) configured to exchange ultra-wideband pulse radio signals.
13. Airport signalling system (100) of any one the preceding clauses, comprising a power source and a power supply line connecting the power source with the at least one signalling unit (200), and preferably the first and/or second relay communication units (500).
14. Airport signalling system (100) of any one the preceding clauses, wherein one or more of the at least two signalling units comprise a second communication device (240) coupled to the power supply line, and wherein the central communication unit (400) is coupled to the power supply line and is configured for data communication with the second communication devices (240) via the power supply line.
15. Airport signalling system (100) of any one the preceding clauses, wherein the at least one signalling unit comprises a first gateway device coupled to the power supply line, and wherein the central communication unit (400) comprises a second gateway device coupled to the power supply line, wherein the second gateway device is configured for data communication with the first gateway devices via the power supply line.
16. Airport signalling system (100) of any one of the preceding clauses, wherein one or more of the at least two signalling units (200) comprise a third communication device for wireless data communication being configured to receive and/or transmit according to a wireless cellular communication protocol to the central communication unit (400), preferably said third communication device is configured to receive and/or transmit 4G LTE or 5G radio signals.
17. Airport signalling system (100) of any one of the preceding clauses, wherein in one or more of the at least two signalling units, at least one of the first (230), the second (240) and third communication devices are configured to operate the at least one airport signalling device (200).
18. Airport signalling system (100) of any one of the preceding clauses, wherein the central communication unit (400) comprises a ultra-wideband communication device and communicates with the first communication device of the at least one signalling unit (200).
19. Airport signalling system (100) of any one of the preceding clauses, wherein in one or more of the at least two signalling units (200), at least two of the first (230), the second (240), third communication device are configured to exchange data between one another.
20. Airport signalling system (100) of any one of the preceding clauses, wherein the central communication unit (400) is configured to receive data from signalling units and/or the control unit (300).
21. Airport signalling system (100) of any one of the preceding clauses, wherein the at least one signalling unit (200) comprises at least one sensor for capturing measurement data in relation to one or more of: a status condition of the respective airport signalling device (210), an environmental condition and a presence of a object, and wherein the at least one sensor is configured to communicate the measurement data to at least one of the first (230), second (240) and/or third communication device.
22. Airport signalling system (100) of any one of the preceding clauses, wherein the central communication unit (400) is configured for data communication with one or more of the at least two signalling units selectively via the first (230), the second (240) or third communication device.

1. Airport signalling system, comprising:
at least two signalling units, each comprising at least one airport signalling device and a first communication device;
a control unit configured to control operation of the at least two signalling units,
a central communication unit operably coupled to the control unit and configured for data communication with the at least two signalling units and the control unit,
characterised in that the first communication device of each signalling unit is configured to receive and transmit ultra-wideband pulse radio signals and in that the at least two signalling units are configured to exchange with one another ultra-wideband pulse radio signals through their respective first communication device.

2. Airport signalling system of claim 1, wherein the first communication device of one or each of the at least two airport signalling units is configured for data communication with at least one moving entity on an airfield, selected from a group consisting of an airplane, a ground vehicle, a ultra-wideband based tag worn by a pedestrian, and a mobile phone, said entity being provided with an ultra-wideband communication device configured to exchange data with at least one first communication device of the at least two signalling unit.

3. Airport signalling system of claim 1, wherein the at least two signalling units comprise at least a first group of signalling units arranged in cluster like structure covering a first zone of interest, and said signalling system further comprising a first relay communication unit, wherein a first signalling unit of the first group is positioned within a ultra-wideband coverage range of the first relay communication unit, said first relay communication unit being a signalling unit configured as a relay for the first group of the signalling units.

4. Airport signalling system of claim 1, wherein one or more of the at least two airport signalling units are an aeronautic ground light, an airport sign, an airport guard light, a flood light, a taxiway light, an apron light or a visual docking guidance display.

5. Airport signalling system of claim 1, further comprising at least one airport surveillance stationary device, and a multilateration ground station, said device being provided with an ultra-wideband communication device configured to exchange data with at least one first communication device of the at least two signalling unit.

6. Airport signalling system of claim 3, wherein the first group of the signalling units are positioned along a first path, said first path being arranged:
in a runway approach, or runway centre line, touch down zone, a taxiway or an apron or
along one or both opposite sides of the one of a runway, taxiway and an apron.

7. Airport signalling system of claim 3, wherein the at least two signalling units comprise a second group of signalling units arranged in cluster like structure to cover a second zone of interest, and said signalling system further comprises a second relay communication unit, wherein a first signalling unit of the second group is positioned within an ultra-wideband coverage range of first relay communication unit, said second relay communication unit being a signalling unit configured as a relay for the second group of signalling units.

8. Airport signalling system of claim 7, wherein at least one of the signalling units of the first group and at least one of the signalling units of the second group are in data communication via their respective first communication device configured to exchange ultra-wideband pulse radio signals.

9. Airport signalling system of claim 1, comprising a power source and a power supply line connecting the power source with the at least two signalling units.

10. Airport signalling system of claim 9, wherein one or more of the at least two signalling units comprise a second communication device coupled to the power supply line, and wherein the central communication unit is coupled to the power supply line and is configured for data communication with the second communication devices via the power supply line.

11. Airport signalling system of claim 9, wherein one or more of the at least two signalling unit comprise a third communication device for wireless data communication being configured to receive and/or transmit according to a wireless cellular communication protocol to the central communication unit.

12. Airport signalling system of claim 11, wherein in one or each of the at least two signalling units, at least one of the first, the second and third communication devices are configured to operate the at least one airport signalling device.

13. Airport signalling system of claim 11, wherein in one or more of the at least two signalling units, at least two of the first, the second, third communication device are configured to exchange data between one another.

14. Airport signalling system of claim 1, wherein the at least two signalling units each comprise at least one sensor for capturing measurement data in relation to one or more of: a status condition of the respective airport signalling device, an environmental condition and a presence of a foreign object, and wherein the at least one sensor is configured to communicate the measurement data to the first communication device.

15. Airport signalling system according to claim 1, wherein the first communication device of one or each of the at least two airport signalling units is configured for data communication with at least one moving entity on an airfield, selected from a group consisting of an airplane, a ground vehicle, a ultra-wideband based tag worn by a pedestrian, and a mobile phone, said entity being provided with an ultra-wideband communication device configured to exchange data with at least one first communication device of the at least two signalling unit, wherein the at least two signalling units comprise at least three signalling units, wherein the first communication device of the at least three signalling units comprising:
a computing unit configured to extract, accumulate and process data received by said first communicating device; and
a power supply;
wherein at least two of the at least three signalling units are configured to exchange with one another ultra-wideband pulse radio signals through their respective first communication device;
the central communication unit being configured for data communication with the at least three signalling units said unit comprising a centralized processor being configured:
to exchange data with the at least one moving entity on an airfield via at least one of the at least three signalling units, and
to calculate a communication path from a first of the at least one moving entity to:
the central communication unit or
to a second of the at least one second moving entity.

16. Airport signalling system according to claim 15, comprising at least one airport surveillance stationary device, comprising a first communication device to receive and transmit ultra-wideband pulse radio signals,
wherein the at least one airport surveillance stationary device and at least one of the at least three signalling units are configured to exchange with one another ultra-wideband pulse radio signals through their respective first communication device;
wherein the central communication unit is further configured to exchange data with the at least one airport surveillance stationary device; and
wherein the communication network comprises the at least one airport surveillance stationary device.

17. Airport signalling system according to claim 15, comprising at least one further moving entity on an airfield, selected from a group consisting of an airplane, a ground vehicle, a UWB based tag worn by a pedestrian, and a mobile phone, said entity being provided with an ultra-wideband communication device configured to exchange data with at least one first communication device of the at least three signalling unit and optionally the at least one airport surveillance stationary device,
wherein the central communication unit is further configured for data communication with the at least one further moving entity,
wherein the centralised processor being configured to exchange data with the at least one further moving entity; and
wherein the communication network further comprises the at least one further moving entity.

18. Airport signalling system according to claim 15, wherein the centralized processor is configured to receive data from the communication network, to merge the data exchanged from the communication network and to select given data out of a group of data exchanged, based on predefined criteria so as to ensure build in redundancy.

19. Airport signalling system according to claim 15, wherein the centralized processor is provided with a memory to store signal parameters of the data exchanged and calculated for one or more communication paths.

20. Airport signalling system according to claim 19, wherein the centralised processor is configured to compare signal strengths of some or all of the data exchanged received in a configurable time window with ranging previously calculated and stored in the memory and associate the ones related to the same entity.

21-26. (canceled)
